(19) United States
(12) Patent Application Publication
(10) Pub. No.: US 2018/0252843 A1
(43) Pub. Date: Sep. 6, 2018

(54) WAVELENGTH CONVERSION DEVICE

(71) Applicant: DELTA ELECTRONICS, INC., Taoyuan City (TW)

(72) Inventors: Po-Tsun KUO, Taoyuan City (TW); Chi CHEN, Taoyuan City (TW); Chun-Hsien LU, Taoyuan City (TW); Yen-I CHOU, Taoyuan City (TW); Keh-Su CHANG, Taoyuan City (TW)

(21) Appl. No.: 15/810,154

(22) Filed: Nov. 13, 2017

Related U.S. Application Data
(60) Provisional application No. 62/465,167, filed on Mar. 1, 2017.

(30) Foreign Application Priority Data
Aug. 15, 2017 (CN) 201710695261.3

(51) Int. Cl. G02B 1/115; G02B 26/00

(52) U.S. Cl. CPC G02B 1/115; G02B 2207/113; G02B 2207/101; G02B 26/008

(57) ABSTRACT

A wavelength conversion device includes a substrate, a wavelength conversion member, and an anti-reflective structure. The wavelength conversion member is disposed on the substrate. The anti-reflective structure includes a plurality of stacking layers sequentially stacked from the wavelength conversion member. Each of the stacking layers is formed by arranging a plurality of nano particles. Porosities of the stacking layers are gradually increased from a first side of the anti-reflective structure facing towards the wavelength conversion member to a second side of the anti-reflective structure facing away from the wavelength conversion member.

### RELATED APPLICATIONS

This application claims priority to U.S. Provisional Application Ser. No. 62/465,167, filed Mar. 1, 2017 and China Application Serial Number 201710695261.3, filed Aug. 15, 2017, which are herein incorporated by reference.

### BACKGROUND

### Technical Field

The present disclosure relates to a wavelength conversion device, and more particularly, to a color wheel device.

### Description of Related Art

A conventional color wheel with reflective phosphor powder includes a substrate coated with a highly reflective layer, and phosphor powder is coated on the highly reflective layer. The highly reflective layer is configured to forwardly reflect the light generated by exciting the phosphor powder with laser. A metal reflective layer, a dielectric multi-layer reflective film, or a metal/dielectric multi-layer reflective film can generally be used as the highly reflective layer.

In general, all materials have their refractive indexes. Therefore, when light passes through two different materials, a scattering loss occurs at the interface between the materials. For example, when an incident light reaches the phosphor powder (n≈1.8) from air (n=0) via the binder medium (n≈1.4 to 1.5) of the phosphor power, about 4-5% of the scattering loss occurs may occur according to the Fresnel law of reflection. If a plurality of films are arranged between the air and the phosphor power, and refractive indexes of the films are gradually increased from the air to the phosphor power in a range between the refractive indexes of the air and the phosphor power, although the scattering loss can be reduced to about 2%, a significant increase in the number of the films will lead to cumbersome coating processes, the decline in the reliability of the films, and significant increase in costs.

### SUMMARY

In view of the foregoing problem, the present disclosure provides a wavelength conversion device which can effectively reduce the scattering loss of incident light.

According to an embodiment, the present disclosure provides a wavelength conversion device. The wavelength conversion device includes a substrate, a wavelength conversion member, and an anti-reflective structure. The wavelength conversion member is disposed on the substrate. The anti-reflective structure includes a plurality of stacking layers sequentially stacked from the wavelength conversion member. Each of the stacking layers is formed by arranging a plurality of nano particles. Porosities of the stacking layers are gradually increased from a first side of the anti-reflective structure facing towards the wavelength conversion member to a second side of the anti-reflective structure facing away from the wavelength conversion member.

In an embodiment of the present disclosure, equivalent refractive indexes of the stacking layers are gradually decreased from the first side to the second side of the anti-reflective structure.

In an embodiment of the present disclosure, a material of the nano particles includes a silicon-based material.

In an embodiment of the present disclosure, the equivalent refractive indexes of the stacking layers are substantially in a range from 1 to 1.5.

In an embodiment of the present disclosure, a material of the nano particles includes an aluminum-based material.

In an embodiment of the present disclosure, the equivalent refractive indexes of the stacking layers are substantially in a range from 1 to 1.8.

In an embodiment of the present disclosure, the porosities are substantially in a range from 5% to 95%.

In an embodiment of the present disclosure, a thickness of the anti-reflective structure is substantially in a range from 100 nanometers to 10 micrometers.

In an embodiment of the present disclosure, the substrate is reflective.

In an embodiment of the present disclosure, the substrate is transmissive. The wavelength conversion device further includes a dichroic layer disposed between the substrate and the wavelength conversion member.

According to another embodiment, the present disclosure provides a wavelength conversion device. The wavelength conversion device includes a phosphor layer and an anti-reflective structure. The phosphor layer has a first refractive index. The anti-reflective structure is formed by stacking a plurality of nano particles. A material of the nano particles includes a silicon-based material or an aluminum-based material. The anti-reflective structure is configured to receive an excitation light from an incident environment. The excitation light enters the phosphor layer via the anti-reflective structure. The incident environment has a second refractive index. Porosities of the anti-reflective structure are gradually increased from a side of the anti-reflective structure proximal to the phosphor layer to a side of the anti-reflective structure distal to the phosphor layer. A refractive index of the anti-reflective structure is between the first refractive index and the second refractive index.

Accordingly, in the anti-reflective structure of the wavelength conversion device of the present disclosure, the stacking layers sequentially stacked from the wavelength conversion member are formed by arranging the nano particles, and the porosities of the stacking layers are gradually increased from the first side of the anti-reflective structure facing towards the wavelength conversion member to a second side of the anti-reflective structure facing away from the wavelength conversion member. Therefore, the wavelength conversion device of the present disclosure can effectively reduce the scattering loss occurred during the incident light enters the wavelength conversion member from the air by adjusting the density of the nano particles in each of the stacking layers, thereby increasing the whole output brightness of the wavelength conversion device. In addition, the wavelength conversion device of the present disclosure also has advantages of simple manufacturing processes, cheap, and etc.

It is to be understood that both the foregoing general description and the following detailed description are by examples, and are intended to provide further explanation of the present disclosure as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a wavelength conversion device according to an embodiment of the present disclosure;

FIG. 2 is a partial enlarged diagram of a wavelength conversion device according to an embodiment of the present disclosure;

FIG. 3 is a schematic diagram of a wavelength conversion device according to another embodiment of the present disclosure;

FIGS. 4A-4D are schematic diagrams illustrating various manufacturing stages of a wavelength conversion device according to an embodiment of the present disclosure;

FIG. 5 is a schematic diagram of manufacturing a wavelength conversion device according to another embodiment of the present disclosure; and

FIG. 6 is a relationship chart of normalized output brightness versus log (thickness) of anti-reflective structure of a wavelength conversion device according to an embodiment of the present disclosure.

### DETAILED DESCRIPTION

Reference will now be made in detail to the present embodiments of the present disclosure, examples of which are illustrated in the accompanying drawings. Wherever possible, the same reference numbers are used in the drawings and the description to refer to the same or like parts.

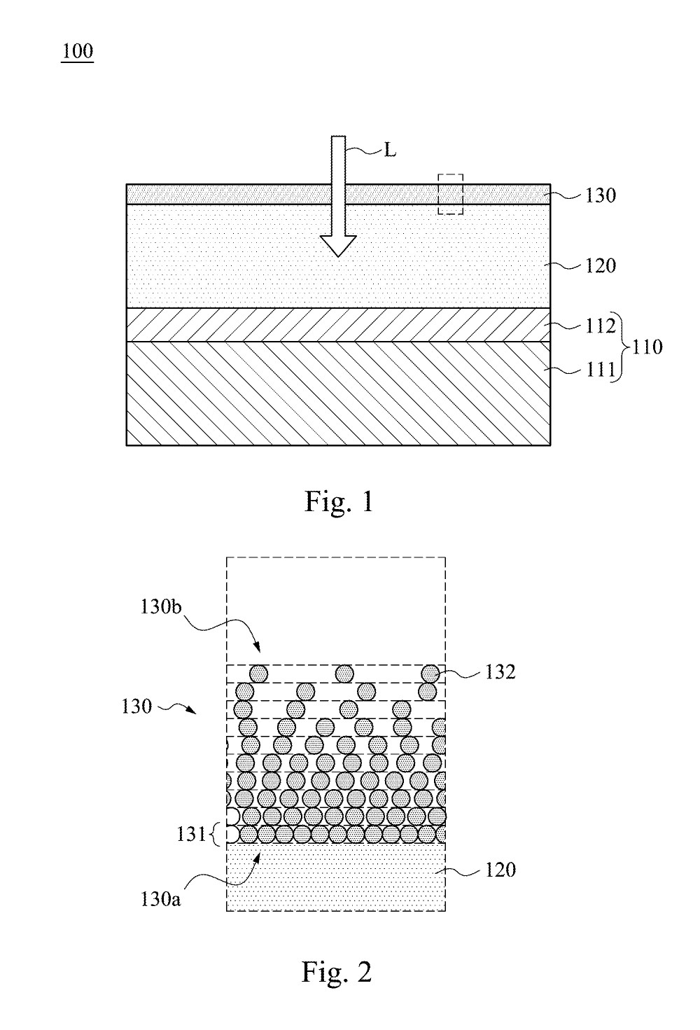

Reference is made to FIGS. 1 and 2. FIG. 1 is a schematic diagram of a wavelength conversion device 100 according to an embodiment of the present disclosure. FIG. 2 is a partial enlarged diagram of a wavelength conversion device 100 according to an embodiment of the present disclosure.

As shown in FIGS. 1 and 2, in the present embodiment, the wavelength conversion device 100 includes a substrate 110, a wavelength conversion member 120, and an anti-reflective structure 130. The wavelength conversion member 120 is disposed on the substrate 110. The anti-reflective structure 130 includes a plurality of stacking layers 131. The stacking layers 131 are sequentially stacked from the wavelength conversion member 120. Each of the stacking layers 131 is formed by arranging a plurality of nano particles 132. Porosities of the stacking layers 131 are gradually increased from a first side 130a of the anti-reflective structure 130 facing towards the wavelength conversion member 120 to a second side 130b of the anti-reflective structure 130 facing away from the wavelength conversion member 120.

In some embodiments, the porosities of the anti-reflective structure 130 are substantially in a range from 5% to 95%. For example, the porosity of the stacking layer 131 closest to the first side 130a is about 5%, and the porosity of the stacking layer 131 closest to the second side 130b is about 95%, but the disclosure is not limited in this regard. The range of the porosities can be adjusted according to actual requirements.

It should be pointed out that if the porosity of a stacking layer 131 is smaller, the incident light entering the stacking layer 131 will be refracted by more nano particles 132, such that the equivalent refractive index of the stacking layer 131 is larger. On the contrary, if the porosity of a stacking layer 131 is larger, the incident light entering the stacking layer 131 will be refracted by less nano particles 132, such that the equivalent refractive index of the stacking layer 131 is smaller. Therefore, because the porosities of the stacking layers 131 are gradually increased from the first side 130a to the second side 130b of the anti-reflective structure 130, equivalent refractive indexes of the stacking layers 131 are gradually decreased from the first side 130a to the second side 130b of the anti-reflective structure 130.

In some embodiments, a material of the nano particles 132 includes a silicon-based material. In some embodiments, the silicon-based material is silicon oxide (SiOₓ), but the present disclosure is not limited in this regard. In some embodiments, the equivalent refractive indexes of the stacking layers 131 formed by the nano particles 132 including the silicon-based material are substantially in a range from 1 to 1.5. In some embodiments, the wavelength conversion member 120 is a phosphor layer, and the refractive index of the wavelength conversion member 120 is greater than 1.5. Therefore, Owing to the refractive indexes from the air to the wavelength conversion member 120 are arranged in a gradient manner, the scattering loss occurred during the incident light reaches the wavelength conversion member 120 from the air via the anti-reflective structure 130 can be effectively reduced according to the Fresnel law of reflection, such that the whole output brightness of the wavelength conversion device 100 can be increased.

In some embodiments, a material of the nano particles 132 includes an aluminum-based material. In some embodiments, the aluminum-based material is aluminum oxide (AlOₓ), but the present disclosure is not limited in this regard. In some embodiments, the equivalent refractive indexes of the stacking layers 131 formed by the nano particles 132 including the aluminum-based material are substantially in a range from 1 to 1.8. In some embodiments, the wavelength conversion member 120 is a phosphor layer, and the refractive index of the wavelength conversion member 120 is greater than 1.8. Therefore, Owing to the refractive indexes from the air to the wavelength conversion member 120 are arranged in a gradient manner, the scattering loss occurred during the incident light reaches the wavelength conversion member 120 from the air via the anti-reflective structure 130 can also be effectively reduced according to the Fresnel law of reflection.

From another point of view, the phosphor layer (i.e., the wavelength conversion member 120) has a first refractive index. The anti-reflective structure 130 is formed by stacking a plurality of nano particles 132. A material of the nano particles 132 includes a silicon-based material or an aluminum-based material. The anti-reflective structure 130 is configured to receive an excitation light L from an incident environment (e.g., the air). The excitation light L enters the phosphor layer via the anti-reflective structure 130. The incident environment has a second refractive index. The porosities of the anti-reflective structure 130 are gradually increased from a side of the anti-reflective structure 130 proximal to the phosphor layer to a side of the anti-reflective structure 130 distal to the phosphor layer. A refractive index of the anti-reflective structure 130 is between the first refractive index and the second refractive index.

In some embodiments, a diameter of the nano particles 132 is substantially in a range from 1 nanometer (nm) to 100 nm. Preferably, the diameter of the nano particles 132 can be further in a range from 5 nm to 50 nm, but the present disclosure is not limited in this regard.

In some embodiments, a thickness of the anti-reflective structure 130 is substantially in a range from 100 nm to 10 micrometers (um). Preferably, the thickness of the anti-reflective structure 130 can be further in a range from 100 nm to 5 um, but the present disclosure is not limited in this regard.

As shown in FIG. 1, in the present embodiment, the substrate 110 includes a base material 111 and a reflective layer 112. The reflective layer 112 is disposed on the base material 111, and the wavelength conversion member 120 is disposed on the reflective layer 112. The base material 111, the reflective layer 112, and the wavelength conversion member 120 form a sandwich stack structure. As discussed above, the wavelength conversion member 120 can be a phosphor layer and can be excited by light (e.g., laser) to emit light, so as to serve as an emitting layer of the wavelength conversion device 100. Hence, with the structural configurations of the wavelength conversion device 100, when light sequentially passes through the anti-reflective structure 130 and the wavelength conversion member 120 from the air to reach the reflective layer 112, the reflective layer 112 can reflect the light transmitted from the wavelength conversion member 120, so that the reflected light then passes through the anti-reflective structure 130 from the wavelength conversion member 120 to leave the wavelength conversion device 100.

In some embodiments, the base material 111 of the substrate 110 can be made of glass, metal (e.g., aluminum), ceramic, or a semiconductor material, but the present disclosure is not limited in this regard.

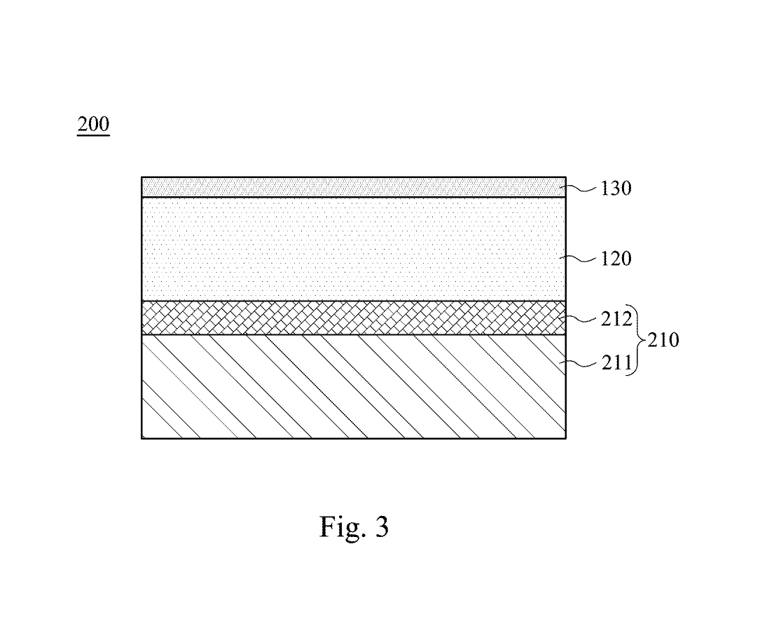

According to the foregoing configurations, it can be understood that the substrate 110 of the embodiment shown in FIG. 1 is reflective, and the wavelength conversion device 100 is a reflective color wheel, but the present disclosure is not limited in this regard. Reference is made to FIG. 3. FIG. 3 is a schematic diagram of a wavelength conversion device 200 according to another embodiment of the present disclosure. As shown in FIG. 3, in the embodiment, the wavelength conversion device 200 includes a substrate 210, a wavelength conversion member 120, and an anti-reflective structure 130, in which the wavelength conversion member 120 and the anti-reflective structure 130 are similar to those of the embodiment shown in FIG. 1, so the introductions of the wavelength conversion member 120 and the anti-reflective structure 130 can be referred to the related discussions above and therefore are not repeated here to avoid duplicity. It should be pointed out that the present embodiment replaces the substrate 110 in FIG. 1 by the substrate 210. Specifically, the substrate 210 includes a base material 211 and a dichroic layer 212. The dichroic layer 212 is disposed on the base material 211, and the wavelength conversion member 120 is disposed on the dichroic layer 212. The base material 211, the dichroic layer 212, and the wavelength conversion member 120 form a sandwich stack structure.

Furthermore, the substrate 210 is transmissive. As discussed above, the wavelength conversion member 120 can be a phosphor layer and can be excited by light (e.g., laser) to emit light, so as to serve as an emitting layer of the wavelength conversion device 200. Hence, with the structural configurations of the wavelength conversion device 200, light can sequentially passes through the base material 211, the dichroic layer 212, the wavelength conversion member 120, and the anti-reflective structure 130 from the air, and then leave the wavelength conversion device 200 from the anti-reflective structure 130. The dichroic layer 212 is configured to separate a predetermined color light from the incident light, and the predetermined color light can be transformed to another predetermined color light by using the wavelength conversion member 120. That is, the wavelength conversion device 200 of the present embodiment is a transmissive color wheel.

In some embodiments, the base material 211 of the substrate 210 can be made of an inorganic material such as ceramic, quartz, glass, etc., but the present disclosure is not limited in this regard.

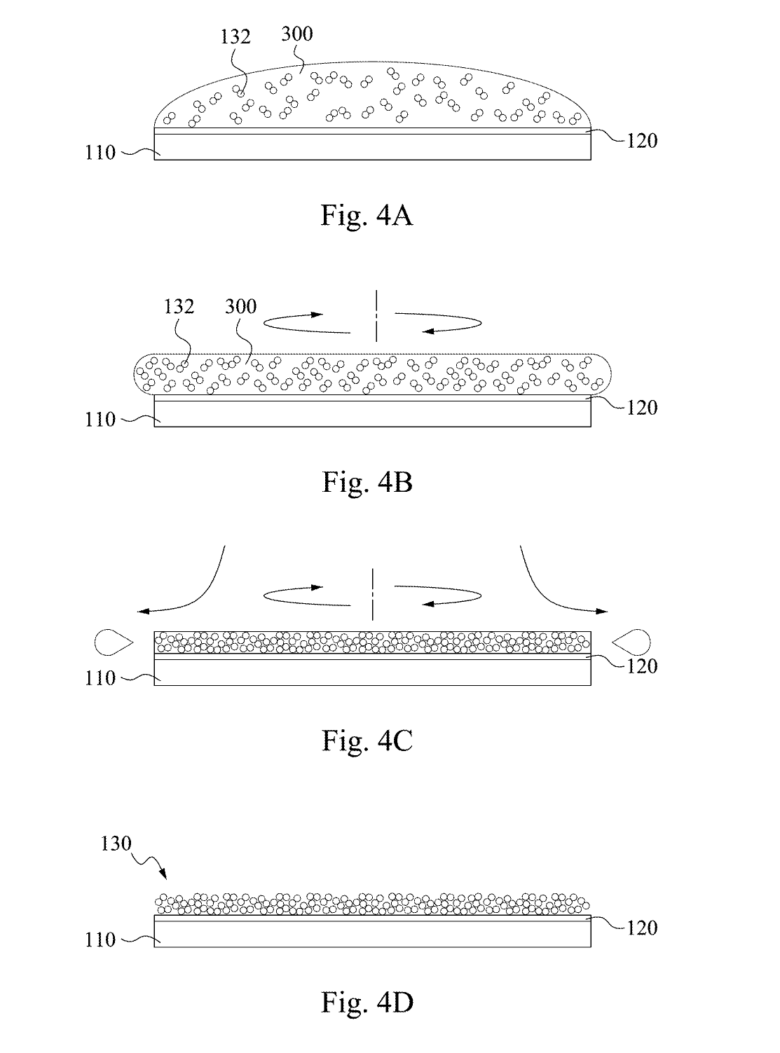

Reference is made to FIGS. 4A-4D. FIGS. 4A-4D are schematic diagrams illustrating various manufacturing stages of the wavelength conversion device 100 according to an embodiment of the present disclosure.

As shown in FIG. 4A, silicon alkoxide or aluminum alkoxide can be evenly mixed with a solvent 300 to form a solution, and the solution can be then applied onto the wavelength conversion member 120 on the substrate 110. In some embodiments, the solvent 300 is organic, but the present disclosure is not limited in this regard. The thickness of the solution on the surface of the wavelength conversion member 120 is not uniform due to the surface tension. In order to uniformly control the thickness of the wavelength conversion member 120, a rotation procedure can be performed to the substrate 110 based on an axis shown in FIG. 4B, and an extra part of the solution will be thrown away from the edge of the wavelength conversion member 120. A combination of the procedures of FIGS. 4A and 4B is the spin-coating process. As shown in FIG. 4C, during the rotation of the substrate 110, the solvent 300 will volatile, so as to make the silicon alkoxide or aluminum alkoxide condense. Afterwards, a thermal process such a back process or a sinter process can be performed to transform the silicon alkoxide or aluminum alkoxide into the nano particles 132 shown in FIG. 4D of which the material respectively includes the silicon oxide or the aluminum oxide. It should be pointed out that the plurality of stacking layers 131 shown in FIG. 2 formed by arranging the nano particles 132 can be manufactured by controlling the rotation rate of the spin-coating process shown in FIGS. 4A and 4B or the concentration recipe, and the porosities and the equivalent refractive indexes of the stacking layer 131 are arranged in a gradient manner.

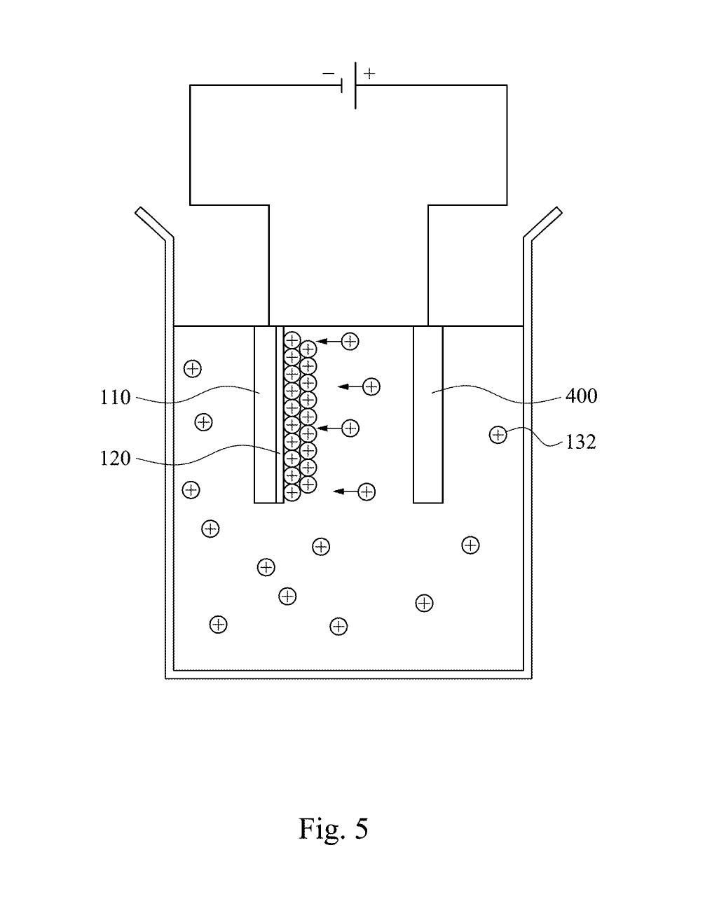

Reference is made to FIG. 5. FIG. 5 is a schematic diagram of manufacturing the wavelength conversion device 100 according to another embodiment of the present disclosure. As shown in FIG. 5, the nano particles 132 or glass beads of which the material includes the silicon oxide or the aluminum oxide can be spread in a solvent to form electrolytes. Afterwards, an auxiliary electrode 400 and the substrate 110 with the wavelength conversion member 120 are immersed in the electrolytes and electrically coupled to the positive and negative electrodes of a power supply respectively, and then an electrophoretic deposition process can be performed. By controlling the voltage of bias of the power supply, the plurality of stacking layers 131 can be manufactured by controlling the arrangement of the nano particles 132, and the porosities and the equivalent refractive indexes of the stacking layer 131 are arranged in a gradient manner. Finally, the substrate 110 can be taken out from the electrolytes, and a thermal process (i.e., a sintering process) can be performed to bind the nano particles 132, so as to obtain the anti-reflective structure 130 shown in FIG. 2 on the wavelength conversion member 120.

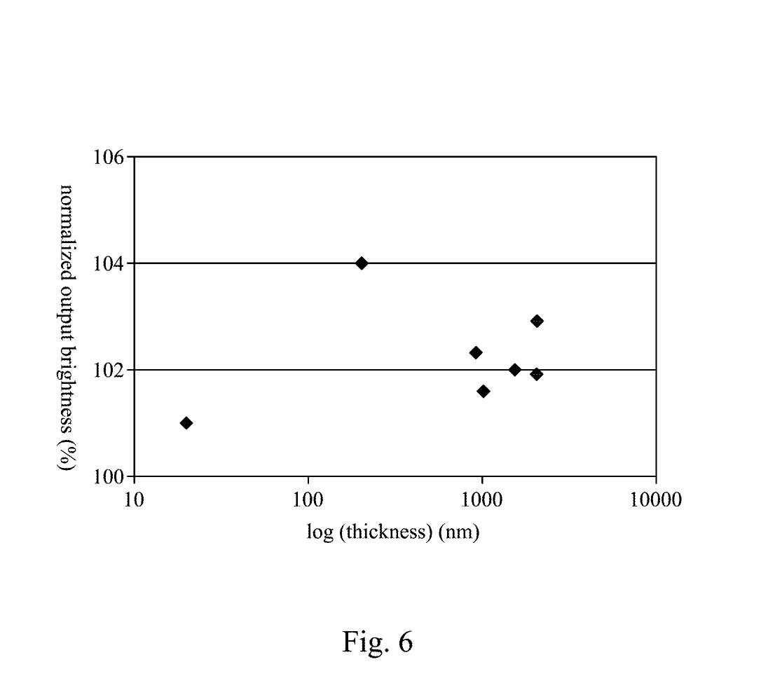

Reference is made to FIG. 6. FIG. 6 is a relationship chart of normalized output brightness versus log (thickness) of anti-reflective structure of the wavelength conversion device 100 according to an embodiment of the present disclosure. In detail, FIG. 6 is a relationship chart of normalized output brightness versus log (thickness) of anti-reflective structure obtained from brightness experiments of reflected light of a wavelength conversion device without the anti-reflective structure 130 and several wavelength conversion devices with the anti-reflective structures 130 of different thicknesses under the same power of laser light source. With the output brightness corresponding to the wavelength conversion device without the anti-reflective structure 130 taken as a comparison basis, the normalized output brightnesses of the wavelength conversion devices with the anti-reflective structures 130 of different thicknesses can be obtained. It can be clearly seen that when the thicknesses of the anti-reflective structures 130 are greater than 100 nm, the normalized output brightnesses of the corresponding wavelength conversion devices can be improved about 2-4%.

According to the foregoing descriptions of the embodiments of the present disclosure, it can be seen that in the anti-reflective structure of the wavelength conversion device of the present disclosure, the stacking layers sequentially stacked from the wavelength conversion member are formed by arranging the nano particles, and the porosities of the stacking layers are gradually increased from the first side of the anti-reflective structure facing towards the wavelength conversion member to a second side of the anti-reflective structure facing away from the wavelength conversion member. Therefore, the wavelength conversion device of the present disclosure can effectively reduce the scattering loss occurred during the incident light enters the wavelength conversion member from the air by adjusting the density of the nano particles in each of the stacking layers, thereby increasing the whole output brightness of the wavelength conversion device. In addition, the wavelength conversion device of the present disclosure also has advantages of simple manufacturing processes, cheap, and etc.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the present disclosure. In view of the foregoing, it is intended that the present disclosure cover modifications and variations of this disclosure provided they fall within the scope of the following claims.

What is claimed is:

1. A wavelength conversion device, comprising:
a substrate;
a wavelength conversion member disposed on the substrate; and
an anti-reflective structure comprising a plurality of stacking layers sequentially stacked from the wavelength conversion member, each of the stacking layers being formed by arranging a plurality of nano particles, porosities of the stacking layers being gradually increased from a first side of the anti-reflective structure facing towards the wavelength conversion member to a second side of the anti-reflective structure facing away from the wavelength conversion member.

2. The wavelength conversion device of claim 1, wherein equivalent refractive indexes of the stacking layers are gradually decreased from the first side to the second side of the anti-reflective structure.

3. The wavelength conversion device of claim 2, wherein a material of the nano particles comprises a silicon-based material.

4. The wavelength conversion device of claim 3, wherein the equivalent refractive indexes of the stacking layers are substantially in a range from 1 to 1.5.

5. The wavelength conversion device of claim 2, wherein a material of the nano particles comprises an aluminum-based material.

6. The wavelength conversion device of claim 5, wherein the equivalent refractive indexes of the stacking layers are substantially in a range from 1 to 1.8.

7. The wavelength conversion device of claim 1, wherein the porosities are substantially in a range from 5% to 95%.

8. The wavelength conversion device of claim 1, wherein a thickness of the anti-reflective structure is substantially in a range from 100 nanometers to 10 micrometers.

9. The wavelength conversion device of claim 1, wherein the substrate is reflective.

10. The wavelength conversion device of claim 1, wherein the substrate is transmissive, and the wavelength conversion device further comprises a dichroic layer disposed between the substrate and the wavelength conversion member.

11. A wavelength conversion device, comprising:
a phosphor layer having a first refractive index; and
an anti-reflective structure formed by stacking a plurality of nano particles, a material of the nano particles comprising a silicon-based material or an aluminum-based material,
wherein the anti-reflective structure is configured to receive an excitation light from an incident environment, the excitation light enters the phosphor layer via the anti-reflective structure, and the incident environment has a second refractive index,
wherein porosities of the anti-reflective structure are gradually increased from a side of the anti-reflective structure proximal to the phosphor layer to a side of the anti-reflective structure distal to the phosphor layer, and a refractive index of the anti-reflective structure is between the first refractive index and the second refractive index.

12. The wavelength conversion device of claim 11, wherein the porosities are substantially in a range from 5% to 95%.

13. The wavelength conversion device of claim 11, wherein a thickness of the anti-reflective structure is substantially in a range from 100 nanometers to 10 micrometers.
